(19) United States
(12) Patent Application Publication
(10) Pub. No.: US 2009/0114682 A1
(43) Pub. Date: May 7, 2009

(54) Easy Access Dispenser

(76) Inventor: Neal B. Gittleman, Houston, TX (US)

Correspondence Address: EZRA L. SCHACHT, 1620 WEST MAIN STREET, HOUSTON, TX, 77006-4712, US

(21) Appl. No.: 11/934,064

(22) Filed: Nov. 1, 2007

(51) Int. Cl. B67D 5/64; B67D 5/06

(52) U.S. Cl. 222/173; 222/179

(57) ABSTRACT

Ungainly attempts to refill antiseptic lotion, or liquid soap containers housed below a sink or vanity cabinet and attached to a surface mounted dispensing pump are addressed by providing a kit of accessories with a larger reservoir and a long, flexible extension tube. The reservoir, in the form of a large bottle or suspended, flexible wailed bag, is supplied with a modified cap and extension tube to allow easy access for replacing the antiseptic fluid container.

### BACKGROUND OF THE INVENTION

Today’s sink side dispensers of antiseptic soaps and lotions are indispensable in the medical and home environment to prevent cross contamination and communication of disease. It has been established throughout the world that clean hands prevent the spread of disease. Sink tops, counter tops, cabinet or vanity tops are often equipped with a built-in, hand pump soap or lotion dispenser that provides a useful amount of soap or lotion with a single downward push. The dispensers are supplied with a refutable or interchangeable container threaded into and directly under the hand pump. This requires the person refilling this container to assume a difficult and uncomfortable position under the sink. This person must often reach back behind downward projecting sink basins and blindly replace the container by feel or to actually crawl into the sink or vanity cabinet to replace the refilled container. The opportunity to spill or contaminate the antiseptic soap or to strain or injure oneself is a known consequence of this maneuver.

Often an attempt is made to refill the container from above by removing parts of the hand pump and pouring in the soap or lotion. This can be a messy opportunity to spill the soap solution or in the case of slow flowing hand lotions or gels, a time consuming process much like pouring honey or ketchup out of a bottle.

The current invention addresses these objections to prior art by providing a flexible extension tube and vessel or reservoir that can be situated in a much more easily accessed location under the sink or vanity. This vessel can be in the form of a PVC jug with a modified cap connecting to the flexible extension tube. The container cap is equipped with a siphon tube communicating from the lowest reaches of the container. A siphon or suction action is provided with each downward push of the hand pump to bring the solution up from the bottom of the container. Small breather openings located within the cap of the container can be equipped with an air filter to allow in the air necessary for proper pumping white excluding any bacteria or debris. Alternately, the container or reservoir can be constructed with flexible walls that collapse upon the withdrawal of fluid.

Alternately, a reservoir in the form of a flexible pouch or container can be suspended in a convenient place under the sink or vanity cabinet. The flexible tube from the hand pump is connected to this flexible container filled with the antiseptic soap or lotion. This pouch is the preferred method of maintaining sterility of the contained solution.

The dispenser, while manually activated in most circumstances, is actuated by alternate means including electrical or foot pedal operation in alternate embodiments of this invention. The dispenser can be mounted on a vertical

### BRIEF DESCRIPTION OF THE DRAWINGS

FIG. 1 is a perspective view of a dispensing pump;

FIG. 2 is an exploded view of a dispensing container with extended access tube and fittings for attachment to a built-in dispenser;

FIG. 3 is a detailed view of the reservoir assembly; and,

FIG. 4 is a view of the flexible pouch container with flexible tubing attached.

### DETAILED DESCRIPTION OF THE DRAWING

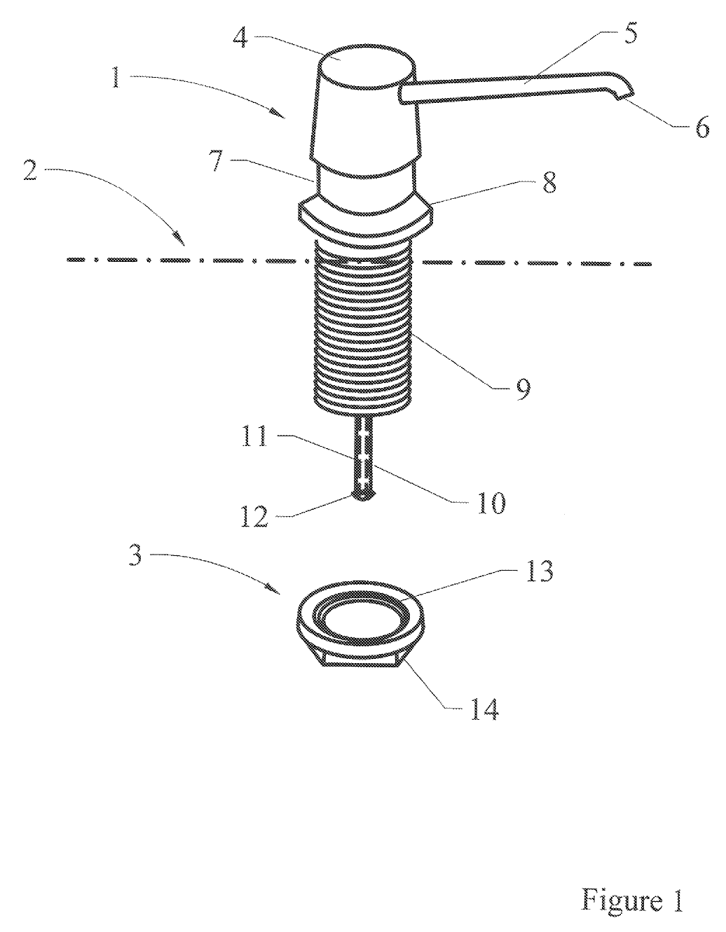

FIG. 1 shows a built-in hand pump dispenser 1 having a top 4 that is pressed down to pump an antiseptic soap, lotion or gel through spigot 5 and out of opening 6. The pump body 7 has a flange 8 that mounts flush with the upper surface of the sink or cabinet represented by line 2. The externally threaded portion 9 of the hand pump extends below the sink or cabinet and is retained in place by threaded nut 3 with internal threads 13 and hex tightening means 14.

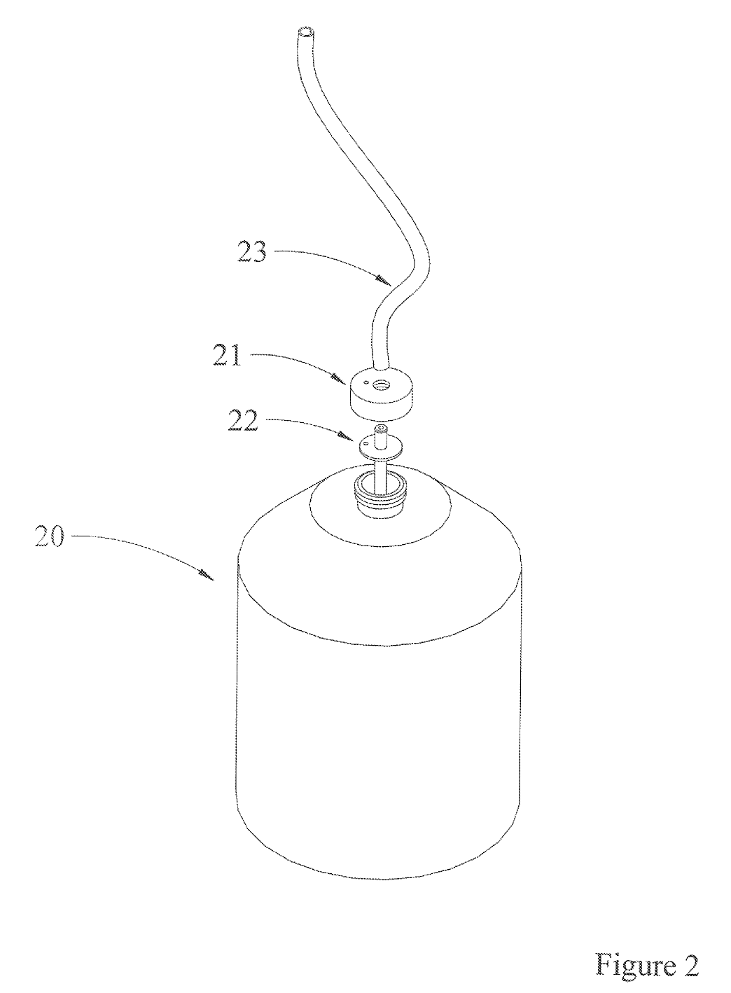

A rigid supply line 10 has a hollow core 11 and a barbed end 12 to retain a hollow flexible length of tubing 23 as shown in FIG. 2.

FIG. 2 details a reservoir 20, which can be a convenient 2 liter or half gallon PVC (poly-vinyl-chloride) container, purchased as a bulk refill of the desired antiseptic fluid or gel, has a siphon tube 22, a closure cap 21 and a length of flexible tubing 23 to connect to the rigid supply line 10 of the hand pump. This reservoir can be place conveniently on the cabinet floor or a shelf at a distance away from the hand pump dispenser 1 itself.

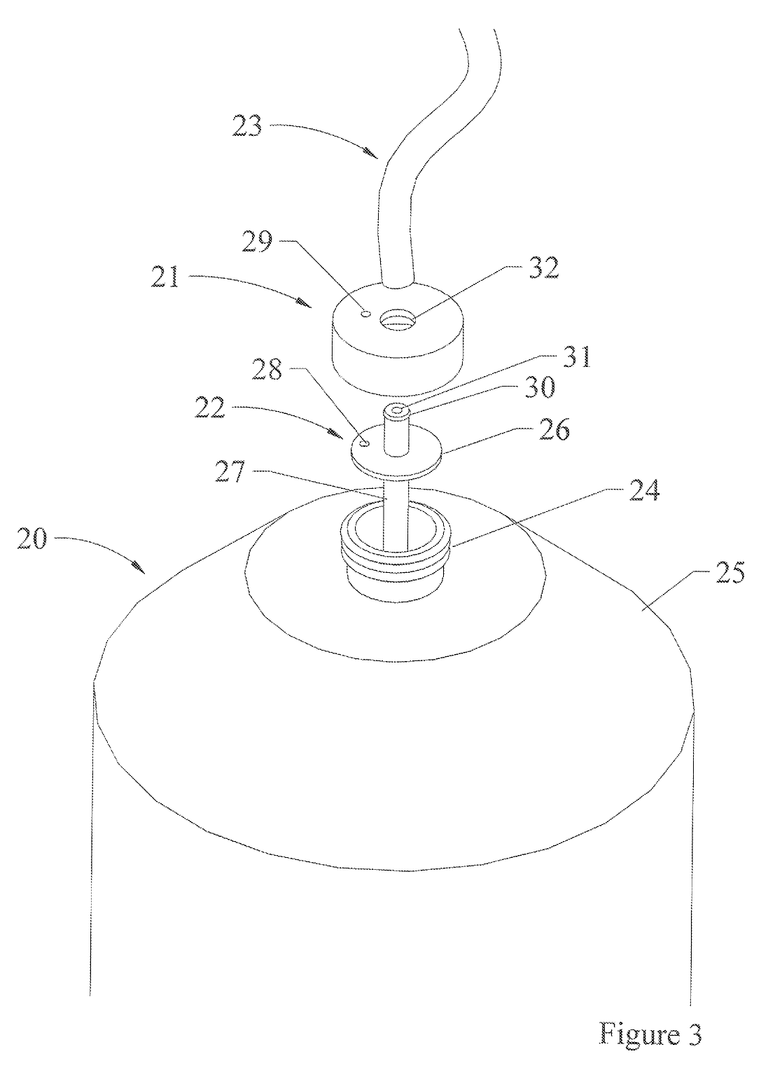

FIG. 3 details the reservoir and associated parts. The reservoir 20 consists of a hollow body 25 having a threaded neck 24. A siphon tube 22 has a hollow tube 27 which reaches to the bottom of the reservoir, a flange 26 with a breather hole 28 and top barbed extension 30. Through-hole 31 conveys the fluid from the bottom of the reservoir to the length of hollow flexible tubing 23. Screw closure 21 has an internal thread that mates with the neck thread 24, an opening 32 for the top barbed extension of the siphon tube and a breather hole 29 to equalize air pressure between the inside and the outside of the reservoir. Flange 26 and closure top 21 have the means to allow holes 28 and 29 to permit air transfer. A HEPA particle filter located between these communicating holes, not shown, can act to prevent debris, dust or bacteria from entering the reservoir during air pressure equalization.

The PVC container, and the related siphon tube and flexible tubing are sold as a refill kit. The PVC jug 20 can be shipped with a plastic seal (not shown) over the threaded neck 24 and the threaded closure 21 in place. The seal is removed and discarded when the refill kit is assembled for use. The advantage of a large bulk reservoir will require fewer refills.

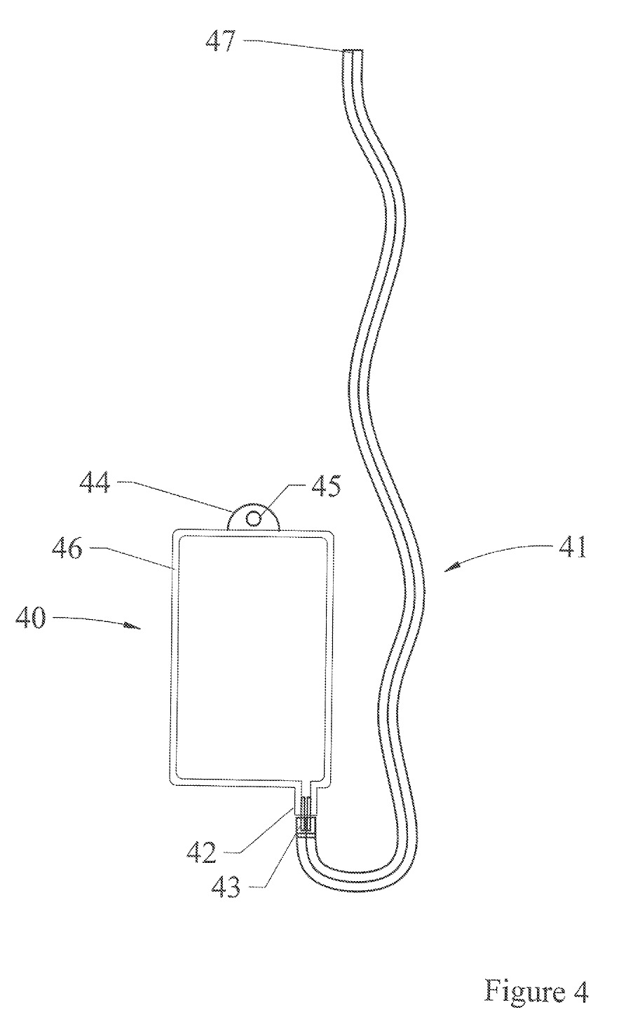

FIG. 4 shows an alternate reservoir consisting of a flexible sealed bag 40 of suitable plastic having a sealed outer perimeter 46, a hanging tab 44 with through hole 45. At the bottom end of the pouch a drain 42 with a hollow stem 43 connect to a length of flexible hollow extension tube 41. The opposite end 47 of the extension tubing is attached to the rigid supply line 10 on the dispenser 1.

The flexible bag has the advantage of continuous sterile delivery by the exclusion of ambient air during use. The flexible walls of the bag simply collapses to supply the antiseptic fluid on demand. The bag is suspended in the inverted position by a hook or other means under the cabinet or sink enclosure.

What is claimed:

1. A built-in, antiseptic fluid dispensing apparatus comprising;
a dispenser, a length of flexible extension tubing;
a remote, easily accessible reservoir with a closure;
a siphon tube communicating from the lowest reaches of said reservoir through said closure and connecting with said flexible extension tube;
and the other end of said flexible extension tube connecting to the supply line of said dispenser, thereby conveying said antiseptic fluid up and out of said reservoir for delivery through said dispenser upon actuation of said dispenser.

2. A built-in, counter-top antiseptic fluid dispensing apparatus as in claim 1, comprising said reservoir with a breather hole in said closure to equalize air pressure.

3. A built-in, counter-top antiseptic fluid dispensing apparatus as in claim 1, comprising said reservoir with said breather holes protected by an air filter to prevent contamination of said antiseptic fluid.

4. A built-in, counter-top antiseptic fluid dispensing apparatus as in claim 1, comprising said reservoir with flexible walls.

5. A built-in, counter-top antiseptic fluid dispensing apparatus as in claim 1, comprising a flexible walled bag as said reservoir.

6. A built-in, counter-top antiseptic fluid dispensing apparatus as in claim 1, comprising electrical means for actuating said dispenser.

7. A built-in, counter-top antiseptic fluid dispensing apparatus as in claim 1, comprising foot pedal operated means for actuating said dispenser.

8. A built-in, counter-top antiseptic fluid dispensing apparatus as in claim 1, comprising said flexible extension tube of sufficient length to insure easy replacement of said reservoir.
